(19) United States
(12) Patent Application Publication
(10) Pub. No.: US 2026/0216989 A1
(43) Pub. Date: Jul. 30, 2026

(54) Roofing System

(71) Applicant: International Insulation Products, LLC, Orlando, FL (US)

(72) Inventor: Dermot Joseph Ennis, Spring Grove, PA (US)

(21) Appl. No.: 19/631,044

(22) Filed: Mar. 27, 2026

Related U.S. Application Data
(63) Continuation-in-part of application No. 18/381,460, filed on Oct. 18, 2023, now Pat. No. 12,643,306.
Application No. 18/381,460 is a division of application No. 15/316,624, filed on Dec. 6, 2016, now abandoned.
(60) Provisional application No. 63/778,434, filed on Mar. 27, 2025.

(51) Int. Cl. B32B 5/02; B32B 5/18; B32B 7/12; B32B 15/04; B32B 15/14; B32B 15/20; B32B 27/36; B32B 37/12; E04D 12/00

(52) U.S. Cl. CPC B32B 5/028; B32B 5/18; B32B 7/12; B32B 15/046; B32B 15/14; B32B 15/20; B32B 27/36; B32B 37/12; E04D 12/002; B32B 2262/101; B32B 2266/025; B32B 2307/304; B32B 2307/3065; B32B 2307/31; B32B 2307/7265; B32B 2419/06

(57) ABSTRACT

A roofing system of a structure, the roofing system includes a roof deck, a barrier layer fastened to the roof deck, and roofing material being disposed over the barrier layer and the roof deck, the roofing material preferably made of nonflammable roofing members being exposed to the outside ambient environment. The barrier layer includes a reflective layer on one side of the barrier layer and a synthetic roofing underlayment forming a liquid water barrier layer on the opposite side of the barrier layer. A thermal insulation layer and a nonflammable layer is disposed between the reflective layer and the liquid water barrier layer. The nonflammable layer and the thermal insulation layer may be embodied as a fiberglass insulation layer.

### RELATED APPLICATIONS

This application is a non-provisional of and claims priority to U.S. Provisional Patent Application Ser. No. 63/778,434 titled “Roofing System” and filed Mar. 27, 2025 with Attorney Docket No. 1-3521-P, and as well this application is a continuation-in-part of and claims priority to and the benefit of the filing date U.S. patent application Serial No. 18/381,460 titled “Roofing Underlayment” filed Oct. 18, 2023 with Attorney Docket No. 1-2041-US-DIV and pending on the filing date of this application, which in turn is a division of now abandoned Ser. No. 15/316,624 titled “Roofing Underlayment” filed Dec. 6, 2016 with Attorney Docket No. 1-2041-US, which in turn is a US nationalization of and claims priority to now expired International Patent Application PCT/US2015/34442 titled “Roofing Underlayment” filed Jun. 5, 2015 with Attorney Docket No. 1-2041-PCT, which in turn claims priority to now expired U.S. Provisional Patent Application No. 62/010,059 titled “Roofing Underlayment” filed Jun. 10, 2014 with Attorney Docket No. 1-2041-P, each of the foregoing priority patent applications being incorporated by reference as if fully set forth herein.

### FIELD OF THE DISCLOSURE

The disclosure relates generally to roofing systems, and in particular, to a roofing system that provides a fire barrier, a water barrier, and thermal resistance.

### BACKGROUND OF THE DISCLOSURE

Roofing systems protect a structure from water damage from rain, snow, and the like falling on the roof. Roofing systems made of a non-flammable (fireproof) roofing material such as concrete, metal, and ceramics can also protect a structure from fire started from hot ash or burning materials falling on the roofing material.

There is a need for an energy-efficient roofing system that provides an additional fire barrier beneath the roofing layer.

### SUMMARY OF THE DISCLOSURE

Disclosed is a roofing system having a non-flammable roofing material being disposed over a barrier layer placed on a roof deck of the roofing system. The barrier layer functions as a fire barrier, a liquid water barrier, and a heat transfer barrier protecting the roof deck.

Other objects and features of the disclosure will become apparent as the description proceeds, especially when taken in conjunction with the accompanying drawing sheets illustrating one or more illustrative embodiments.

### BRIEF DESCRIPTION OF THE DRAWINGS

FIG. 1 is a side view of a first embodiment roofing system in accordance with this disclosure.

FIG. 2 is a sectional view through the length of the barrier layer of the roofing system shown in FIG. 1.

FIG. 3 is a side view of a second embodiment roofing system in accordance with this disclosure.

FIG. 4 is a side view of a third embodiment roofing system in accordance with this disclosure.

FIG. 5 is a side view of a fourth embodiment roofing system in accordance with this disclosure.

### DETAILED DESCRIPTION

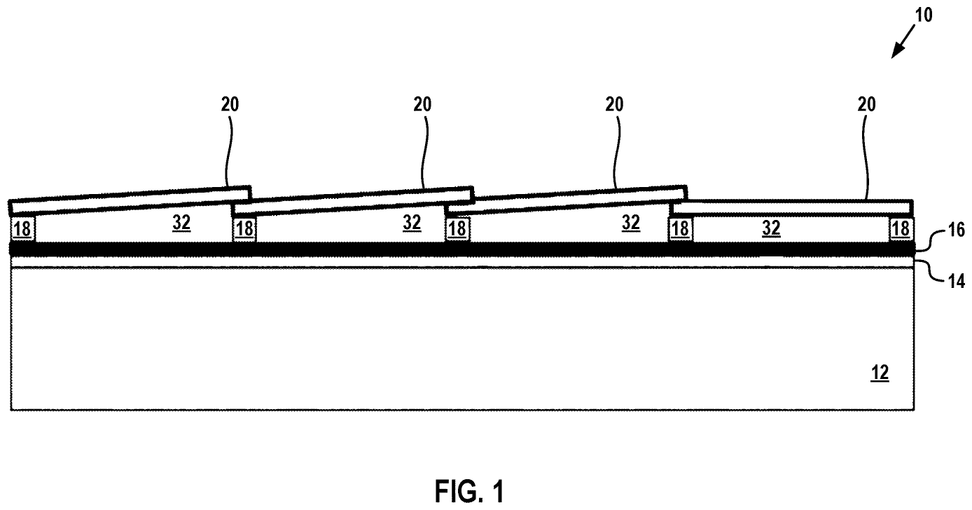

FIG. 1 illustrates a first embodiment roofing system 10 for a structure in accordance with this disclosure. The roofing system includes framing 12 consisting of a number of parallel 2×6 dimensional lumber (1.5 inches×5.5 inches in cross-section) joists extending in a longitudinal direction along the lengths of the joists and being spaced uniformly spaced apart from one another in a transverse direction perpendicular to the FIG. 1 drawing sheet. End portions of the joists are supported on conventional supporting structures (not shown) that transmit the loads supported by the joists to the ground.

Sheathing provided as ⅝-inch thick OSB (oriented strand board) sheets define a roof deck 14 that forms a first continuous layer spanning and covering the top of the framing 12.

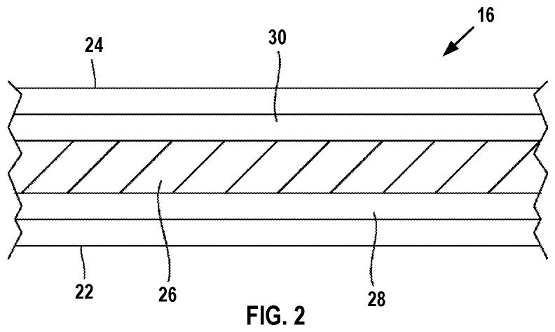

Disposed on and covering the roof deck 14 is a second continuous layer 16 that will be described in more detail below. The second layer 16 is of a multi-layer construction that as shown in FIG. 2 includes a synthetic roofing underlayment layer 22 on a first side of the second layer 16, a reflective insulation layer 24 on the opposite second side of the second layer 16, and a non-flammable thermal insulation layer 26 being disposed between the first and second layers.

Referring back to FIG. 1, extending in the transverse direction on top of the second layer 16 are a number of uniformly spaced apart ¾ inch battens 18 placed on top of the second layer. The battens support non-flammable roofing members formed as tiles 20 as shown in FIG. 1. The battens space the tiles 20 above the second layer 16 whereby the tiles do not contact the second layer 16.

The illustrated tiles 20 are flat concrete roof tiles that extend end-to-end parallel with the length direction of the framing 12. The tiles are each supported on opposite ends against adjacent pairs of battens 18 or only against an end batten 18 as shown in FIG. 1. Adjacent ends of adjacent pairs of the concrete roof tiles underlap/overlap one another to cover seams between adjacent end-to-end tiles. Rows of concrete roof tiles are placed side-by-side along the transverse direction parallel with the battens. Adjacent side-by-side concrete roof tiles can also overlap one another to cover seams between adjacent side-by-side concrete roof tiles. The roof tiles 20 are disposed on the outside of the roof to be exposed to the outside ambient environment.

The second layer 16 is discussed in more detail next. A cross-section of the second continuous layer 16 is shown in FIG. 2. The second layer 16 includes a synthetic roofing underlayment 22 formed on one side of the second layer, a reflective insulation 24 formed on the opposite second side of the second layer, and a non-flammable thermal insulation 26 being disposed between the synthetic roofing underlayment and the reflective insulation layer.

The synthetic roofing underlayment can be attached to the thermal insulation by an adhesive layer 28 and the reflective insulation can be attached to the thermal insulation by an adhesive layer 30 (the thickness of the adhesive layers are exaggerated and drawn not to scale in FIG. 2). An adhesive layer can be formed from a hot melt adhesive, a heat seal film (flame activated or not flame activated), glue, or other suitable adhesive.

The second layer 16 functions as a barrier layer that provides a heat transfer barrier, a fire barrier, and a liquid water barrier protecting the roof deck 14, and so will also be referred to as a barrier layer 16 herein. A non-limiting example of a suitable commercially available barrier layer that provides a heat transfer barrier, a fire barrier, and a liquid water barrier is disclosed in my US Patent Application Publication 2017/0210089, incorporated herein by reference as if fully set forth herein, and sold under the trademark SOL-R-SKIN® by the applicant herein.

The synthetic roofing underlayment layer 22 functions as the liquid water barrier of the barrier layer 16. The reflective insulation layer 24 and the thermal insulation layer 26 layer each function as barrier to infrared heat transfer and to conductive heat transfer respectively. The reflective layer 24 reduces heat radiative heat transfer from the sun into the interior of the structure. The thermal insulation layer 26 reduces heat transfer between the structure's interior and exterior. The illustrated thermal insulation layer 26 is inflammable and also functions as the fire barrier of the barrier layer 16. Other embodiments of the barrier layer 16 may include a fire barrier layer separate from the thermal insulation layer 26.

The liquid water barrier of the barrier layer 16 formed by the synthetic roofing underlayment 22 is described next. 1 roofing underlayment as used herein is a construction material normally disposed and sandwiched between a roof deck and a roofing material. Non-limiting examples of roofing materials include asphalt roofing shingles, ceramic or concrete roofing tiles, metal roofing panels, and the like.

A roofing underlayment is a waterproof membrane that functions as a liquid water barrier. A synthetic roofing underlayment is a synthetic roofing underlayment manufactured from synthetic (man-made) materials. A non-synthetic roofing underlayment includes natural waterproof materials such as bitumen (asphalt).

A roofing underlayment is normally disposed and sandwiched over a roof deck and under a roofing material. The roofing underlayment functions as a waterproof membrane that protects the roof deck from liquid water not diverted off the roof by the roofing material. A waterproof membrane as used herein is a membrane that substantially resists or prevents the passage of liquid water through the waterproof membrane. A waterproof membrane protects a structure from liquid water entering the structure. A roofing underlayment protects the structure from liquid water entering through the roof (and ideally prevents liquid water passing through the roofing material from reaching the roof deck). Other types of waterproof membranes may protect the structure from liquid water entering through the foundation or sides of the structure.

A roofing underlayment may be glued to the roof deck or may fastened to the roof deck by fasteners (for example, staples, nails, plastic cap nails, etc.) that extend through the roofing underlayment and into the roof deck. The roofing material may be fastened to the roof deck by fasteners (such as, for a non-limiting example, roofing nails) that also pass through the roofing underlayment previously fastened to the roof deck.

A roofing underlayment must maintain its ability to be a waterproof membrane even with the roofing underlayment fasteners and the roofing material fasteners extending through the roofing underlayment. To remain a waterproof membrane, the roofing underlayment may “self-seal” around the fasteners that extend through the roofing underlayment, and resist tearing caused by the holes in the roofing underlayment generated by the passage of the fasteners through the roofing underlayment .. A synthetic roofing underlayment may include a plastic woven or nonwoven fabric that resists tearing in the areas where fasteners pass through the roofing underlayment.

A roofing underlayment may be exposed to external weather elements such as snow, rain, sleet, ice, sunshine, wind, heat, cold, and the like during installation of the roofing underlayment onto the roof deck and before the roofing materials can be placed over the roofing underlayment. The roofing underlayment may also be exposed to the weather elements during repair or replacement of the roofing materials, which could exceed over six months of exposure (note, a roofing underlayment is not intended for indefinite external weather exposure and is not intended to be used permanently as a roof material).

A roofing underlayment then must also be capable of functioning as a waterproof membrane attached to the roof deck for a reasonable length of time without being covered by any roofing materials. The roofing underlayment must protect the roof deck while being exposed to rain, snow, freezing temperatures, UV radiation, and the like while the roof is being constructed or is being repaired.

Roofers must also be able to walk on the roofing underlayment during installation or while making roof repairs without destroying the ability of the roofing underlayment to function as a waterproof membrane during the installation or repair.

A vapor barrier is often confused with a waterproof membrane and so the differences will be discussed next.

A vapor barrier substantially resists or prevents the passage of water vapor (water in the gaseous state) through the vapor barrier. Vapor barriers are typically used to control humidity within a structure or to prevent condensation of water vapor caused, for example, by water vapor moving from a warm interior of a structure to a cold interior surface of the structure (such as the interior surface of an outer wall or insulation covering the interior surface of the outer wall during the cold of winter). A vapor barrier is often placed on the warm side of thermal insulation that is against the interior surface of the outer wall to resist condensation of water vapor within the thermal insulation that has diffused from the warm side into the thermal insulation. Water condensing in the insulation absorbs heat from the warm side of the insulation, lowering the effective resistance to heat transfer of the insulation.

Because a vapor barrier protects against diffusion of water molecules through the vapor barrier, a vapor barrier is often a plastic film, typically a 4 mil- 6 mil thick polyethylene film. The plastic film alone is not suitable as a roofing underlayment in the environment of use expected for a roofing underlayment. In sum, a vapor barrier is placed to resist or prevent diffusion of water vapor while a roofing underlayment is used to resist or prevent liquid water from reaching or infiltrating a roof deck even under extreme conditions. Because the operational demands, environment of use demands, and forces imposed on a roofing underlayment are different than the operational demands, environment of use demands, and forces imposed on a vapor barrier, a roofing underlayment and a vapor barrier are not equivalent and interchangeable construction materials.

Plastic films may be incorporated into roofing underlayments. For example, a roofing underlayment constructed as well-defined layers may use plastic films in adhering adjacent layers to each other. Plastic films may be placed on top of a roofing underlayment to provide a base for building up an improved traction surface, or may be temporarily attached to the roofing underlayment to protect the underlying surface of the roofing underlayment that is removed prior to application of the roofing underlayment against the roof deck. But the plastic films are not used alone as a roofing underlayment.

On the other hand, a roofing underlayment can be a “breathable underlayment” that allows diffusion of water vapor (not liquid water) through the roofing underlayment or may be a “non-breathable” roofing underlayment that essentially prevents diffusion of water vapor through the roofing underlayment. A breathable roofing underlayment or a non-breathable roofing underlayment are each considered a roofing underlayment herein because it is intended for use as and can function as a waterproof roofing underlayment that functions as a barrier to liquid water as described herein.

The roofing underlayment 22 includes a conventional synthetic roofing underlayment that enables the barrier layer 16 to function as a roofing underlayment. A synthetic roofing underlayment is made from man-made materials, examples of which include (but are not limited to) woven and nonwoven polypropylene, woven or nonwoven polyethylene, or other polymers as is known in the synthetic roofing underlayment art. Examples of synthetic roofing underlayments that can possibly be adapted for use as the synthetic roofing underlayment 22 are disclosed in Strait, U.S. Pat. No. 8,765,251, Sandhar et al. U.S. Pat. No. 11,787,162, Thai et al. US Patent Application Publication 2010/0178827, Seth US Patent Application Publication 2019/0344542, and Seth US Patent Application Publication 2019/0344543. Other synthetic roofing underlayments are commercially available.

The illustrated reflective insulation 24 is made of aluminum film or aluminum foil disposed on one side of the barrier layer 16. In addition to reflecting sunlight and ultraviolet rays to resist heat transfer into the barrier layer 16, the reflective insulation 24 assists the synthetic roofing underlayment 22 in being an additional waterproof layer of the barrier layer 16.

The illustrated thermal insulation 26 is made of nominally ⅜ (three-eighths) inch thick fiberglass. Polyethylene foam, an organic insulation material, or other suitable non-flammable thermal insulating material can be used. The thermal insulation 26 resists conductive heat transfer through the thickness of the thermal insulation from a warmer side of the thermal insulation to a colder side of the thermal insulation. The thickness of the thermal insulation can be selected to meet a desired R value.

The illustrated thermal insulation 26 is a non-flammable fiberglass insulation and also forms the fire barrier of the barrier layer 16. The aluminum reflective insulation 24 is also technically non-flammable (fireproof) but it is not relied upon as being a fire barrier of the barrier layer 16.

The illustrated SOL-R-SKIN® barrier layer 16 is a CalFire-listed (BLM 4310-2283:0500) Class A fire-rated underlayment designed for Wildland Urban Interface (WUI) compliance. The SOL-R-SKIN® barrier layer also helps a roof assembly in meeting the burning brand test of the current Underwriters Laboratory, LLC. (UL) 790 standard or the current ASTM International E108 standard for Class A classification of roof assemblies for external fire performance. UL is located at 333 Pfingsten Road, Northbrook, IL 60062 United States of America. ASTM International is located at 100 Barr Harbor Drive, West Conshohocken, PA, 19428, United States of America.

The barrier layer 16 is attached to the roof deck 14 in accordance with the manufacturer's installation instructions. The illustrated barrier layer 16 is placed over the roof deck with the synthetic roofing underlayment 22 against the roof deck. The barrier layer 17 is then fastened to the roof deck using corrosion resistant plastic cap nails. A cap nail is a roofing nail with a plastic cap around the head. Cap nails assist in resisting high winds from tearing off the barrier layer while the fastened barrier layer 16 is not covered by roofing materials.

The battens 18 are against the barrier layer 16 and space the concrete roof tiles 20 away from the barrier layer. There are air gaps 32 defined between adjacent pairs of the battens that extend between the barrier layer 16 and the overlaying concrete roof tiles.

The concrete roof tiles 20 are non-flammable and also assist in resisting structure fires from starting caused by hot ashes or burning matter falling onto the roof. Other non-flammable, fire resistant roofing materials, including but not limited to ceramics, steel, other metals, fiberglass, or the like can also be used as a fire-resistant roofing material 20.

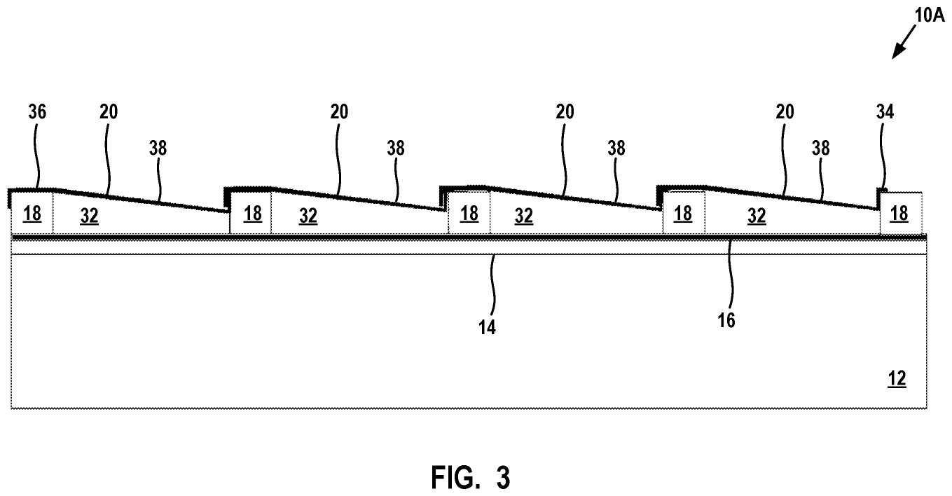

FIG. 3 illustrates a second embodiment roofing system 10A in accordance with this disclosure. The same reference numbers used in describing the first embodiment roofing system 10 will be used in referencing corresponding elements of the second embodiment roofing system 10A. The roofing system 10A also includes non-flammable, fire-resistant roof tiles 20 Supported on adjacent pairs of battens 18 that define air gaps 32 between the roof tiles and the barrier layer 16.

The roofing system 10A has framing 12, a roof deck 14, a barrier layer 16, and battens 18 that are identical to and are disposed in the same manner as the corresponding elements of the first embodiment roofing system 10 and so will not be described in further detail.

The roofing materials 20 are made of like non-flammable concrete roof tiles but are non-flat roof tiles. Each roof tile 20 includes a first L-shaped end portion 34 on one end of the tile and a second L-shaped end portion 36 on the opposite second end of the tile. An intermediate flat tile portion 38 extends from the first end portion 34 to the second end portion 36 and connects the end portions.

Each tile 20 is supported against an adjacent pair of battens 18. The illustrated rows of tiles are formed by placing a first tile 20 over a starting pair of battens, and continuing the row by overlapping the tiles to the end of the row. The tiles define air gapes 32 between the tiles and the barrier 16 that extend across the gap between adjacent pairs of battens.

The first end portion 34 of the tile is configured to extend over and partially cover the top of the batten supporting that end of the tile. The second end portion 36 of the tile is configured to extend over the full top width of the batten and the first end portion of the immediately adjacent tile (if present). The flat tile portion 38 defines an acute included angle with the roof deck 14.

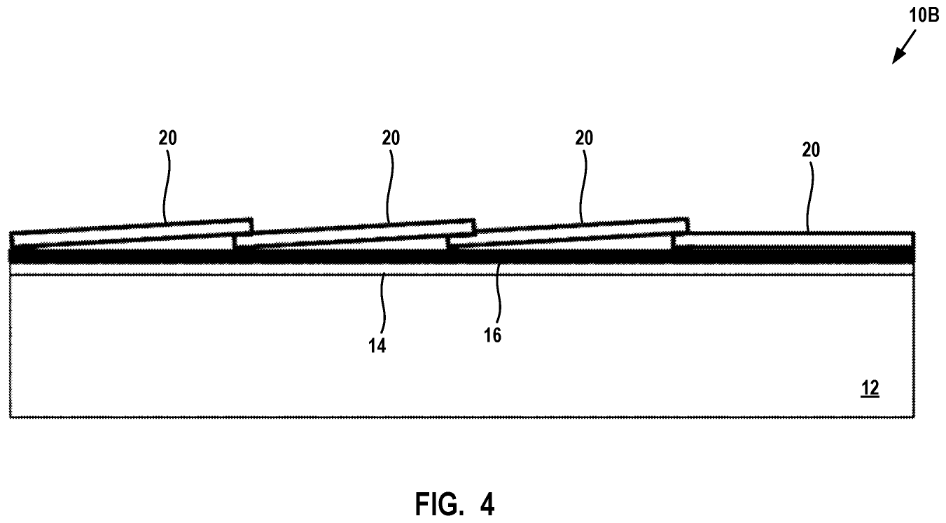

FIG. 4 illustrates a third embodiment roofing system 10B in accordance with this disclosure. The same reference numbers used in describing the first embodiment roofing system 10 will be used in referencing corresponding elements of the third embodiment roofing system 10B.

The roofing tiles 20 are identical to the roofing tiles 20 of the first embodiment roofing system 10. The third embodiment roofing system differs from the first embodiment roofing system 10 only in the battens 18 being removed and the tiles resting directly against the barrier 16.

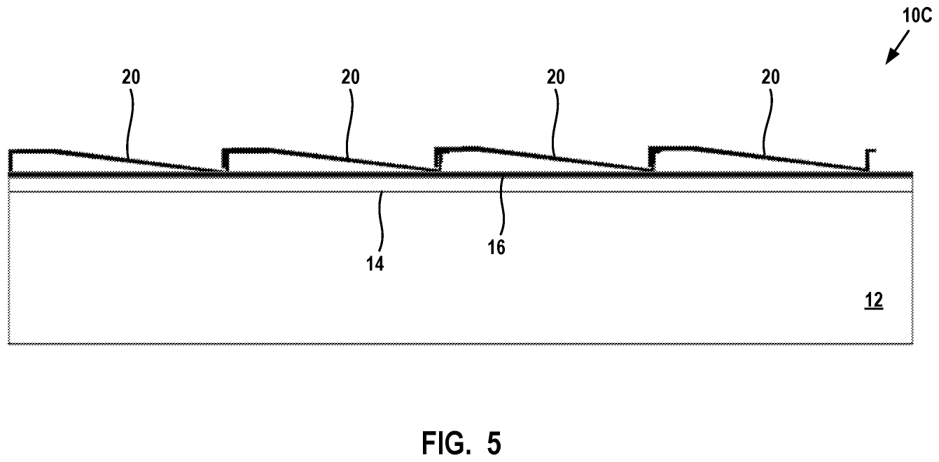

FIG. 5 illustrates a fourth embodiment roofing system 10C in accordance with this disclosure. The same reference numbers used in describing the second embodiment roofing system 10A will be used in referencing corresponding elements of the fourth embodiment roofing system 10C.

The roofing tiles 20 are identical to the roofing tiles 20 of the second embodiment roofing system 10A. The fourth embodiment roofing system differs from the second embodiment roofing system 10A only in the battens 18 being removed and the tiles resting directly against the barrier 16.

FIGS. 1, 3, 4, and 5 illustrate the construction of respective embodiments of a roofing system having roofing materials disposed over a roof deck in accordance with this disclosure. The figures are drawn with the roof deck parallel with the long edge of the drawing page to illustrate construction of the roofing system. The roof deck in each of the figures in practice may have a slope of 2/12 (vertical rise/horizontal run) or less (generally referred to as a flat roof in the roofing industry), a slope of 2/12 to 4/12 (generally referred to as a low slope roof in the roofing industry), a slope of 4/12 to 9/12 (generally referred to as a conventional slope roof in the roofing industry), a slope of 9/12 to 20/12 (generally referred to as a higher slope roof in the roofing industry), or a slope of 20/12 or greater (generally referred to as a steep slope roof in the roofing industry). Comparatively steeper sloped roofs typically shed water more efficiently than do comparatively lower sloped roofs. Two layers of the barrier 16 may be provided in roofs having a lower slope to compensate for the less efficient shedding of water.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art.

What is claimed is:

1. A roofing system of a structure, the roofing system comprising:
a roof deck;
a barrier layer being disposed on the roof deck and being fastened to the roof deck;
roofing material being disposed above both the barrier layer and the roof deck, said roofing material being disposed exposed to the outside ambient environment;
the barrier layer comprising a reflective layer on a first side of the barrier layer, a synthetic roofing underlayment on a second side of the barrier layer opposite the first side, a nonflammable layer between the reflective layer and the synthetic roofing underlayment, and a thermal insulation layer between the reflective layer and the synthetic roofing underlayment.

2. The roofing system of claim 1 wherein the roofing material comprises a plurality of concrete tiles.

3. The roofing system of claim 2 wherein the plurality of concrete tiles are a plurality of flat concrete tiles.

4. The roofing system of claim 2 wherein the plurality of concrete tiles are a plurality of “Z” shaped concrete tiles.

5. The roofing system of claim 1 wherein the roofing material comprise overlapping adjacent pairs of roofing members.

6. The roofing system of claim 1 wherein the roofing material is disposed on the barrier layer.

7. The roofing system of claim 1 wherein the roofing material is spaced away from the barrier layer.

8. The roofing system of claim 1 wherein battens space the roofing material away from the barrier layer.

9. The roofing system of claim 1 wherein the roof deck has a slope of 4/12 or greater.

10. The roofing n 1 wherein the synthetic roofing underlayment of the barrier layer is against the roof deck.

11. The roofing system of: claim 1 wherein the thermal insulation layer of the barrier layer is a fiberglass insulation layer.

12. The roofing system of claim 1 wherein the reflective layer of the barrier layer comprises an aluminum film disposed on the first side of the barrier layer.

13. The roofing system of claim 1 wherein the barrier layer is fastened to the roof deck by fasteners passing through the barrier layer and into the roof deck.

14. The roofing system of claim 1 wherein the roofing system meets the burning brand test of the Underwriters Laboratory, LLC. (UL) 790 standard or the ASTM International E108 standard for Class A classification of roof assemblies in effect on the earliest priority date of this application.

15. The roofing system of claim 1 wherein the nonflammable layer comprises fiberglass.

16. The roofing system of claim 1 wherein the nonflammable layer and the thermal insulation layer is formed as a single layer of material.

17. The roofing system of claim 1 wherein the single layer of material forming the nonflammable layer and the thermal insulation layer is an inflammable fiberglass insulation layer.

18. The roofing system of claim 1 wherein the roofing materials are made of an inflammable material.

19. The roofing system of claim 1 wherein the roofing materials are made of at least one of the following materials: concrete, clay, and slate.
